(19) United States
(12) Patent Application Publication
(10) Pub. No.: US 2025/0124027 A1
(43) Pub. Date: Apr. 17, 2025

(54) DATA PROCESSING METHOD, ELECTRONIC DEVICE AND MEDIUM

(71) Applicant: Beijing Volcano Engine Technology Co., Ltd., Beijing (CN)

(72) Inventors: Leilei HU, Beijing (CN); Kejian JU, Beijing (CN); Yuanpu DING, Beijing (CN)

(21) Appl. No.: 18/883,999

(22) Filed: Sep. 12, 2024

(30) Foreign Application Priority Data
Oct. 11, 2023 (CN) 202311315613.X

(51) Int. Cl. G06F 16/2453

(52) U.S. Cl. CPC G06F 16/2453

(57) ABSTRACT

Embodiments of the present application provide a data processing method and apparatus, an electronic device, and a medium. The method includes: receiving a data query request for a first data processing engine; selecting a target data processing engine from a data processing engine candidate set in a front-end node based on the data query request; if the target data processing engine is the first data processing engine, parsing the data query request in the front-end node, and sending a parsing result to a back-end node, so that the back-end node performs data query; if the target data processing engine is a second data processing engine, generating target information in the front-end node based on the data query request, and sending the target information to the second data processing engine, so that the second data processing engine obtains data from the first data processing engine for data query.

### CROSS-REFERENCE TO RELATED APPLICATION

The present application claims priority of Chinese Patent Application No. 202311315613.X, filed on Oct. 11, 2023, and the entire content disclosed by the Chinese patent application is incorporated herein by reference as part of the present application for all purposes under the U.S. law.

### TECHNICAL FIELD

Embodiments of the present disclosure relate to the field of computer technologies, and specifically relate to a data processing method and apparatus, an electronic device and a medium.

### BACKGROUND

An OLAP (Online Analytical Processing, online analytical processing) system is one of main applications of a data warehouse system, can be used to support complex analytical operations, focuses on decision support for decision makers and top management, and can quickly and flexibly process complex queries with large data volumes according to requirements of analysts and provide query results to the decision makers. However, when data to be processed reaches a particular order of magnitude (for example, a PB order of magnitude), the existing OLAP system cannot process the data due to insufficient memory, relatively long running time, or other reasons. Therefore, the problem that the existing OLAP system cannot problem data with a relatively high order of magnitude urgently needs to be resolved.

### SUMMARY

At least one embodiment of the present disclosure provides a data processing method, which comprises: receiving a data query request for a first data processing engine, wherein the first data processing engine comprises a front-end node and a back-end node, the front-end node receives the data query request, and the back-end node stores data; selecting a target data processing engine from a data processing engine candidate set in the front-end node based on the data query request, wherein the target data processing engine performs data processing on the data query request, the data processing engine candidate set comprises the first data processing engine and a second data processing engine, and a data processing capability of the second data processing engine is higher than a data processing capability of the first data processing engine; and in response to the target data processing engine being the first data processing engine, parsing the data query request in the front-end node, and sending a parsing result to the back-end node, so that the back-end node performs data query; or in response to the target data processing engine being the second data processing engine, generating target information in the front-end node based on the data query request, and sending the target information to the second data processing engine, so that the second data processing engine obtains data from the first data processing engine for data query.

At least one embodiment of the present disclosure further provides a data processing apparatus, which comprising: a receiving unit, configured to receive a data query request for a first data processing engine, wherein the first data processing engine comprises a front-end node and a back-end node, the front-end node receives the data query request, and the back-end node stores data; a selection unit, configured to select a target data processing engine from a data processing engine candidate set in the front-end node based on the data query request, wherein the target data processing engine performs data processing on the data query request, the data processing engine candidate set comprises the first data processing engine and a second data processing engine, and a data processing capability of the second data processing engine is higher than a data processing capability of the first data processing engine; a first processing unit, configured to: in response to the target data processing engine being the first data processing engine, parse the data query request in the front-end node, and send a parsing result to the back-end node, so that the back-end node performs data query; and a second processing unit, configured to: in response to the target data processing engine being the second data processing engine, generate target information in the front-end node based on the data query request, and send the target information to the second data processing engine, so that the second data processing engine obtains data from the first data processing engine for data query.

At least one embodiment of the present disclosure further provides an electronic device, which comprises: at least one processor; and at least one memory, storing one or more programs, wherein upon the one or more programs being executed by the at least one processor, the at least one processor is enabled to implement the data processing method provided by any of the above embodiments of the present disclosure.

At least one embodiment of the present disclosure further provides a non-transient computer-readable medium, storing a computer program, wherein the computer program, upon being executed by a processor, perform the data processing method provided by any of the above embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of an embodiment of a data processing method according to the present disclosure;

FIG. 2 is a schematic diagram of a processing manner of a data processing method according to the present disclosure;

FIG. 3 is a schematic diagram of a data pulling manner of a data processing method according to the present disclosure;

FIG. 4 is a flowchart of an embodiment of selecting a data processing engine in a data processing method according to the present disclosure;

FIG. 5 is a schematic structural diagram of an embodiment of a data processing apparatus according to the present disclosure;

FIG. 6 is an example system architectural diagram to which each embodiment of the present disclosure is applicable; and

FIG. 7 is a schematic structural diagram of a computer system of an electronic device adapted to implement an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged between a plurality of apparatuses in implementations of the present disclosure are used for illustrative purposes only and are not intended to limit the scope of these messages or information.

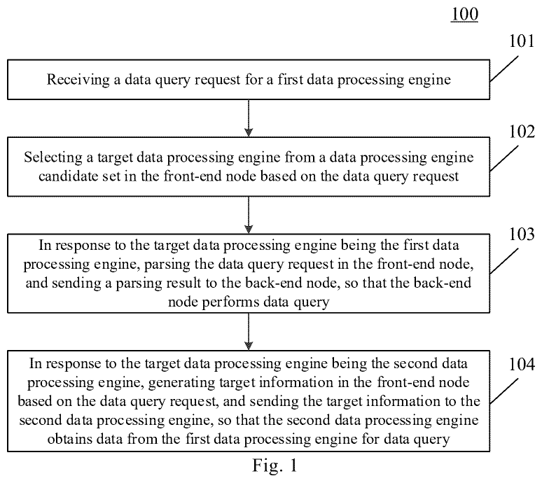

FIG. 1 shows a flow 100 of an embodiment of a data processing method according to the present disclosure. The data processing method includes the following steps:

Step 101: receiving a data query request for a first data processing engine.

In this embodiment, an execution body of the data processing method may receive the data query request for the first data processing engine. The data query request is usually an SQL (Structured Query Language) statement, and the SQL is a database language with a plurality of functions such as data manipulation and data definition. This language has interactive features, and can provide great convenience for users. A database management system should fully use the SQL language to improve working quality and efficiency of a computer application system.

Lakehouse is a new open architecture, gets through a data warehouse and a data lake, and integrates high performance and management capabilities of the data warehouse with flexibility of the data lake. The bottom layer supports coexistence of a plurality of data types, and can implement mutual sharing between data, and the upper layer may be accessed through uniform encapsulation interfaces, and can support real-time query and analysis at the same time, bringing more convenience to data governance of enterprises.

Herein, the first data processing engine usually includes a front-end node (FrontEnd, FE) and a back-end node (BackEnd, BE). The front-end node is usually configured to receive the data query request. In addition, the front-end node may be further configured to carry out work such as managing metadata, managing client connections, performing query parsing planning, generating a query execution plan, and query scheduling (delivering a query to the BE for execution). Data in the first data processing engine is usually stored in the back-end node. In addition, the back-end node may be further configured to carry out work such as querying execution of an execution plan and managing duplicates. To be specific, the first data processing engine is usually the data warehouse in the lakehouse.

Step 102: selecting a target data processing engine from a data processing engine candidate set in the front-end node based on the data query request.

In this embodiment, the execution body may select the target data processing engine from the data processing engine candidate set in the front-end node of the first data processing engine based on the data query request. The target data processing engine is usually a data processing engine that performs data processing on the data query request. The data processing engine candidate set may include the first data processing engine and a second data processing engine. A data processing capability of the second data processing engine is usually higher than a data processing capability of the first data processing engine.

Herein, the second data processing engine is usually the data lake in the lakehouse.

For example, the first data processing engine may have a data analysis with a TB (trillions of bytes) data order of magnitude, and the second data processing engine may have a data analysis capability with a PB data order of magnitude and above. 1 PB=1024 TB.

Herein, the front-end node may analyze the data query request, to determine whether a computing logic of the data query request is a simple logic or a complex logic. If the simple logic is determined, the first data processing engine may be selected as the target data processing engine. If the complex logic is determined, the second data processing engine may be selected as the target data processing engine.

Step 103: in response to the target data processing engine being the first data processing engine, parsing the data query request in the front-end node, and sending a parsing result to the back-end node, so that the back-end node performs data query.

In this embodiment, if the selected target data processing engine is the first data processing engine, the execution body may parse the data query request in the front-end node, and send the foregoing parsing result to the back-end node, so that the back-end node performs data query.

Specifically, the front-end node may parse the data query request, to determine a storage position that is of data queried by the data query request and that is in a data table of the back-end node, and generate a data query task, and may send the storage position of the data and the data query task to the back-end node. After receiving the storage position of the data and the data query task, the back-end node may execute the data query task, and obtain the data from the corresponding storage position for data query and data analysis.

Step 104: in response to the target data processing engine being the second data processing engine, generating target information in the front-end node based on the data query request, and sending the target information to the second data processing engine, so that the second data processing engine obtains data from the first data processing engine for data query.

In this embodiment, if the selected target data processing engine is the second data processing engine, the execution body may generate the target information in the front-end node based on the data query request, and send the target information to the second data processing engine, so that the second data processing engine obtains the data from the first data processing engine for data query.

Specifically, the front-end node may directly use the data query request as the target information for transmission to the second data processing engine. After receiving the data query request, the second data processing engine may parse the data query request, and obtain corresponding data from the first data processing engine by using the parsing result, for data query.

For example, the parsing result may include the storage position that is of the data queried by the data query request and that is in the back-end node of the first data processing engine.

In the method provided in the foregoing embodiment of the present disclosure, the data query request for the first data processing engine is received; then, the first data processing engine itself or the second data processing engine that has a higher processing capability is selected, from the data processing engine candidate set based on the data query request in the front-end node of the first data processing engine, as the data processing engine that performs data processing on the data query request; and if the first data processing engine is selected, the data query request is parsed in the front-end node, and the parsing result is sent to the back-end node, so that the back-end node performs data query; or if the second data processing engine is selected, the target information is generated in the front-end node based on the data query request, and the target information is sent to the second data processing engine, so that the second data processing engine obtains the data from the first data processing engine for data query. In this manner, when the first data processing engine cannot perform data analysis on the received data query request with a larger order of magnitude, the second data processing request with the higher processing capability is used to perform data analysis on the data stored in the first data processing engine, to meet the requirement of the lakehouse.

In some optional implementations, the execution body may further select the target data processing engine from the data processing engine candidate set in the front-end node based on the data query request in the following manner: determining, in the front-end node, storage information corresponding to the data queried by the data query request. The storage information may include at least one of the following: space of a storage table, a partition number, and a file number. The space of the storage table usually means space of a storage table in which the data queried by the data query request is located. The partition number usually means a quantity of areas from which the data queried by the data query request is originated. The file number usually means a quantity of files from which the data queried by the data query request is originated.

Then, the front-end node may perform at least one of the following comparisons: comparison between the space of the storage table and a preset space threshold, comparison between the partition number and a preset partition number threshold, and comparison between the file number and a preset file number threshold. If it is determined that at least one of the following is met: the space of the storage table is greater than the preset space threshold, the partition number is greater than the preset partition number threshold, and the file number is greater than the preset file number threshold, the second data processing engine may be selected to perform data processing on the data query request. In this manner, the data processing engine is selected based on information about the space occupied by the data queried by the data query request, to select a relatively suitable data processing engine to process the data.

In some optional implementations, the execution body may further select the target data processing engine from the data processing engine candidate set in the front-end node based on the data query request in the following manner: determining, in the front-end node, a resource consumption predicted value in a process of processing the data query request. The resource may include but is not limited to at least one of the following: a CPU (Central Processing Unit, central processing unit), a memory, a network, and I/O (Input/Output, input/output).

Then, the front-end node may compare the resource consumption predicted value with the preset resource consumption threshold. If it is determined that the resource consumption predicted value is greater than the preset resource consumption threshold, the execution body may select the second data processing engine to perform data processing on the data query request. In this manner, the data processing engine is selected based on a resource consumption status of the data queried by the data query request in the processing process, to select a relatively suitable data processing engine to process the data.

In some optional implementations, if the second data processing engine is selected to perform data processing on the data query request, the execution body may generate the target information in the front-end node based on the data query request, and send the target information to the second data processing engine in the following manner: parsing the data query request in the front-end node, to obtain a first dataset, where the first dataset can be processed by the first data processing engine.

Then, the front-end node may determine whether the first dataset can be converted into a second dataset, where the second dataset can be processed by the second data processing engine. A correspondence table of correspondence between first dataset and second dataset may be stored in the front-end node, and the front-end node may determine, based on the correspondence table, whether the first dataset can be converted into the second dataset.

If it is determined that the first dataset can be converted into the second dataset, the front-end node may convert the first dataset into the second dataset based on the correspondence table, and then may use the second dataset as the target information for transmission to the second data processing engine. This manner can enable the second data processing engine to further analyze a parsing result of the first data processing engine.

For example, if the first data processing engine is StarRocks, and the second data processing engine is Spark, an SQL statement needs to be parsed, at the FE of the StarRocks engine, into a task that can be recognized by the Spark engine. After the SQL statement is parsed at the FE, an executable physical execution plan is obtained, but the physical execution plan cannot be recognized by the Spark engine, and needs to be converted according to a particular rule.

For example, an operator Scan Operator for query in the StarRocks engine may be converted into a RDD related to readFile of the Spark engine; an exchange operator Exchange Operator in the StarRocks engine may be converted into a RDD related to Reduce in Spark; an aggregate operator Aggregate Operator in the StarRocks engine may be converted into an RDD related to join (inner join) in Spark; and a sort operator Sort Operator in the StarRocks engine may be converted into a RDD related to sort in Spark.

In some optional implementations, after whether the first dataset can be converted into the second dataset is determined, if it is determined that the first dataset cannot be converted into the second dataset, the front-end node may use the data query request as the target information for transmission to the second data processing engine. In other words, for an operator that is not covered, the FE directly sends the SQL statement to the Spark engine.

In some optional implementations, if the first data processing engine is selected to perform data processing on the data query request, the execution body may parse the data query request in the front-end node, and send the parsing result to the back-end node, so that the back-end node performs data query in the following manner: parsing the data query request in the front-end node, to generate the physical execution plan. The physical execution plan is an execution tree formed by physical operators. The SQL statement undergoes processing in phases such as parser and analyze to finally generate the physical execution plan. Then, the physical execution plan may be split into a plurality of plan fragments (PlanFragment), a fragment instance is created according to the plurality of plan fragments, and the fragment instance is sent to the back-end node.

Herein, the PlanFragment is a part of the physical execution plan. Only after the physical execution plane is split into several PlanFragments by the FE, parallel execution by a plurality of machines can be performed. The PlanFragment also includes physical operators, and also includes DataSink. An upstream PlanFragment sends data to an Exchange operator of a downstream PlanFragment through DataSink.

The Fragment Instance is an execution instance of the PlanFragment. A table of StarRocks is split into several tablets through partitions and buckets. Each tablet is stored on a computing node in a form of a plurality of duplicates. The PlanFragment may be instantiated into a plurality of Fragment Instances to process the tablets distributed on different machines, so as to implement parallel data computing. The FE determines a quantity of Fragment Instances, and a target BE that executes the Fragment Instances, and then the FE delivers the Fragment Instances to the BE.

A pipeline may be used to process the fragment instances in the back-end node, to query the data, thereby providing a manner in which the first data processing engine processes the data query request. The Pipeline is a chain including a group of operators. A SourceOperator is used as a starting operator of the Pipeline, and generates data for subsequent operators of the Pipeline. A SinkOperator is used as an ending operator of the Pipeline, absorbs a computing result of the Pipeline, and outputs data.

In an execution engine of the Pipeline, a PipelineBuilder on the BE further splits the PlanFragment into several Pipelines, and each Pipeline is instantiated into a group of PipelineDrivers according to a parallelism parameter of the Pipeline. The PipelineDriver is an instance of the Pipeline, and is also a basic task that can be scheduled by the execution engine of the Pipeline.

In some optional implementations, the first data processing engine may include a massively parallel processing (MPP) database. For example, the first database may be StarRocks, which is a new-generation top-speed full-scene MPP database. The vision of StarRocks is to enable data analysis of users to become simpler and more agile. The users can support top-speed analysis of a plurality of data analysis scenes by using StarRocks without complex preprocessing. StarRocks has a concise architecture, uses an all-around vectorized engine, and is equipped with an all-new designed CBO (Cost Based Optimizer) optimizer, and the query speed (especially for multi-table associated query) is far greater than those of similar products. StarRocks can well support real-time data analysis, and can implement efficient query of real-time updated data. StarRocks further supports a modern materialized view, to further accelerate query. By using StarRocks, the user may flexibly construct various models including a big wide table, a star model, and a snowflake model. StarRocks is compatible with the MySQL (an open-source relational database management system) protocol, supports standard SQL syntax, and is easy for interconnection for use. The whole system has no external dependency, is highly available, and is easy for operation and maintenance management.

The second data processing engine may include a distributed computing framework. For example, the second data processing engine may be Spark, which is an open-source distributed computing framework specially designed for large-scale data analysis processing. A memory computing technology and a directed acyclic graph (DAG) are used to provide an analysis processing capability higher than that of the MapReduce engine. Spark has an offline analysis capability of a PB level and above.

Because StarRocks uses the MPP architecture, StarRocks is applicable to a real-time data warehouse scenario. However, when a data volume reaches the PB data order of magnitude, StarRocks cannot be basically used for data processing, because the memory is insufficient, running duration is relatively long, and when an executed task fails, there is no retry mechanism. In this case, Spark may be used to resolve such a problem. Therefore, StarRocks and Spark may be combined to meet real-time quality (a data real-time analysis capability of the TB data order of magnitude) and a large data volume (an offline analysis capability of the PB data order of magnitude and above).

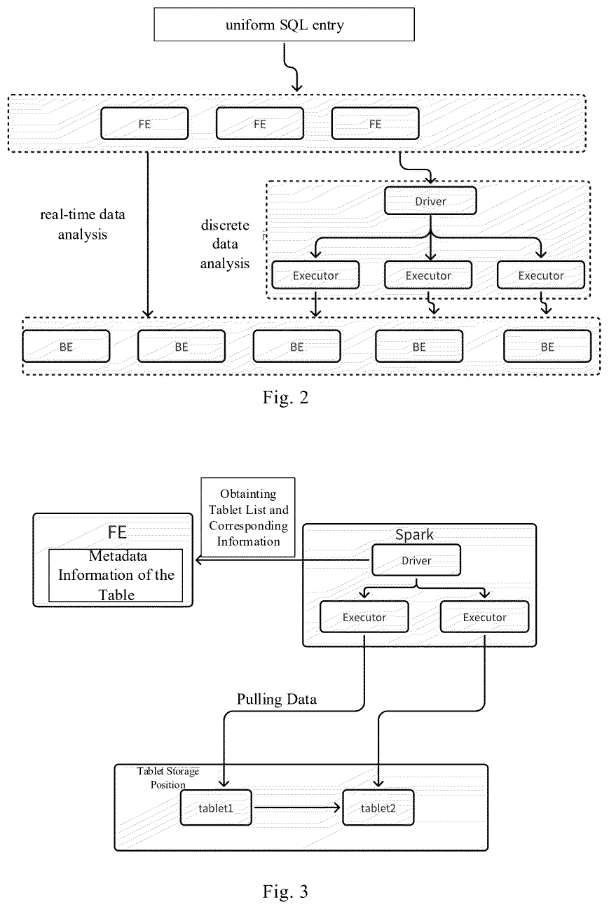

FIG. 2 is a schematic diagram 200 of a processing manner of a data processing method. In FIG. 2, a StarRocks cluster usually includes FEs and many BEs. The FE means FrontEnd, that is, the front-end node of StarRocks, and is mainly responsible for work such as cluster management of metadata, managing client connections, performing query parsing planning, generating a query execution plan, and query scheduling (delivering a query to the BE for execution). The BE means BackEnd, that is, the back-end node of StarRocks, and is mainly responsible for work such as data storage, execution of the query execution plan, and duplicate management. Data of each table is split into a plurality of Tablets according to a partition or bucket mechanism. For fault tolerance, many duplicates are created for the Tablets, and these Tablets are finally distributed on different BEs.

SparkContext is an entry of a Spark computing framework, and is responsible for functions such as managing Spark distributed resources, creating RDDs (Resilient Distributed Datasets), and scheduling a task. SparkSession is an entry of SparkSQL, and is responsible for parsing, analyzing, and optimizing SQL, generating a physical plan, and scheduling and running an SQL task. Driver is a process carrying SparkContext in the Spark distributed processing framework, and is responsible for running SparkContext and scheduling and managing Executor. There is only one Driver. Executor is an execution process that executes distributed tasks, and is responsible for executing tasks distributed by Driver. There are a plurality of Executors.

The SQL statement enters the FE of StarRocks through a uniform SQL entry. The FE may parse the SQL statement, to determine whether to perform real-time data analysis through the StarRocks engine or perform discrete data analysis through the Spark engine. If the StarRocks engine is used, the FE sends an execution task to the BE for data analysis. If the Spark engine is used, the FE sends the execution task to Driver, Driver schedules execution processes of a plurality of Executors, and Executor queries data stored at the BE.

In some optional implementations, the data query request may include an engine identifier of a specified data processing engine. The user may automatically analyze features of the SQL statement, manually specify a to-be-processed data processing engine, and add the engine identifier of the data processing engine to the data query request. The execution body may further select the target data processing engine from the data processing engine candidate set in the front-end node based on the data query request in the following manner: selecting, from the data processing engine candidate set, the data processing engine specified by the data query request, to perform data processing on the data query request. In this manner, selection of the data processing engine can better meet the requirement of the user.

It should be noted that, if the user specifies the StarRocks engine, the SQL statement needs to meet the syntax of StarRocks; or if the user specifies the Spark engine, SparkSQL needs to be responsible for parsing and executing the SQL statement, and therefore the SQL statement needs to meet the syntax of SparkSQL.

In some optional implementations, if the second data processing engine is selected to perform data query on the data query request, the front-end node may be further configured to generate the target information based on the data query request and send the target information to the second data processing engine in the following manner: using the data query request as the target information for transmission to the second data processing engine. In other words, in a scenario in which the user manually specifies the data processing engine, if the second data processing engine is specified, the second data processing engine is responsible for parsing and executing the SQL statement.

In some optional implementations, the target information sent to the second data processing engine is the data query request. After generating the target information based on the data query request, and sending the target information to the second data processing engine, the front-end node may determine whether metadata is buffered in the second data processing engine, where the metadata is metadata of the data table that stores the data queried by the data query request. The metadata of the table is data about table data, including table definition and field attributes to table relations and permissions, and additional metadata includes data analysis and statistical information, such as indexes and partitions.

If it is determined that no metadata is buffered in the second data processing engine, the metadata may be obtained from the front-end node, and the metadata is buffered into a memory of the second data processing engine. In the second data processing engine, the metadata may be used to obtain the data from the first data processing engine for data query. In this manner, a requirement of querying data by the second data processing engine in the first data processing engine can be met.

In some optional implementations, when an operator that can be processed by the Spark engine cannot be obtained through conversion in a dataset conversion process, or in a scenario of manually specifying the Spark engine for data analysis, SparkSQL is responsible for parsing and executing the SQL statement. In this case, SparkSQL needs to know metadata of the table of the SQL statement. The FE is the front-end node of StarRocks, and is responsible for work such as managing metadata, managing client connections, performing query planning, and query scheduling. Each FE node reserves complete metadata in a memory, so that each FE node can provide undifferentiated services. Spark may send, to the FE by using an Http (Hypertext Transfer Protocol) engine, a request for metadata information, and buffers the metadata information into a memory. When reading the metadata information next time, Spark views whether the metadata information is buffered in the memory; and if yes, directly reads the memory; and otherwise, sends the request to the FE again.

In some optional implementations, after whether the metadata is buffered in the second data processing engine is determined, if it is determined that the metadata is buffered in the second data processing engine, in the second data processing engine, the metadata may be used to obtain the data from the first data processing engine for data query. In this manner, locally stored metadata can be directly used to obtain the data from the first data processing engine, to avoid obtaining metadata first before data processing each time, thereby improving data processing efficiency and reducing resource occupation.

In some optional implementations, the execution body may obtain the data from the first data processing engine by using the metadata in the second data processing engine, for data query in the following manner: sending a data obtaining request to the front-end node by using the metadata in the second data processing engine, and receiving data fed back by the front-end node for data query. The data obtaining request is used to request to obtain the data queried by the data query request. In this manner, the second data processing engine can obtain the data from the first data processing engine, to perform corresponding data query and data analysis.

In some optional implementations, the execution body may obtain the data from the first data processing engine by using the metadata in the second data processing engine, for data query in the following manner: directly performing data pulling in the back-end node by using the metadata in the second data processing engine, so as to perform data query on pulled data. In this manner, the second data processing engine (for example, Spark) can directly pull the data from a data storage position (for example, the back-end node), and the data is not forwarded by the front-end node, so as to improve efficiency of reading and writing the data in the first data processing engine by the second data processing engine.

In some optional implementations, the data in the back-end node is stored in data tablets, and the metadata includes metadata of the data tablets, for example, indexes and positions of the data tablets.

The execution body may perform data pulling in the back-end node by using the metadata in the following manner: generating at least one data pulling task according to the data tablets, where one data pulling task herein may pull data corresponding to at least one data tablet. For example, one data pulling task may pull data corresponding to three data tablets. Then, the at least one data pulling task may be executed, to perform data pulling in the back-end node.

Herein, the data pulling task may be divided according to the quantity of data tablets included in one BE. To be specific, one Executor execution process may pull data of data tablets on one BE.

FIG. 3 is a schematic diagram 300 of a data pulling manner of a data processing method. In FIG. 3, data in StarRocks is usually stored in units of Tablets, and Tablet is the minimum data management unit in StarRocks.

Spark divides tasks and reads data in granularities of Tablets. The Driver end of Spark obtains the metadata information from the FE, for example, a Tablet list and corresponding information, performs task division, and distributes tasks to the Executor end, and the Executor end directly pulls data from a Tablet physical storage position of the BE for calculation.

In this manner, Spark can directly pull the data from the data storage position (that is, the BE), and the data is not forwarded by the FE, so as to improve efficiency of reading and writing the data in the StarRocks engine by the Spark engine.

In some optional implementations, a processing result for the data query request may be obtained, in the front-end node, from the second data processing engine. Because the task of the Spark engine is initiated by the FE of the StarRocks engine and the FE also needs to monitor an execution status of the task, the FE periodically sends a task execution status obtaining request to the Driver end of the Spark engine. In this case, the first data processing engine can monitor the task execution status of the second data processing engine.

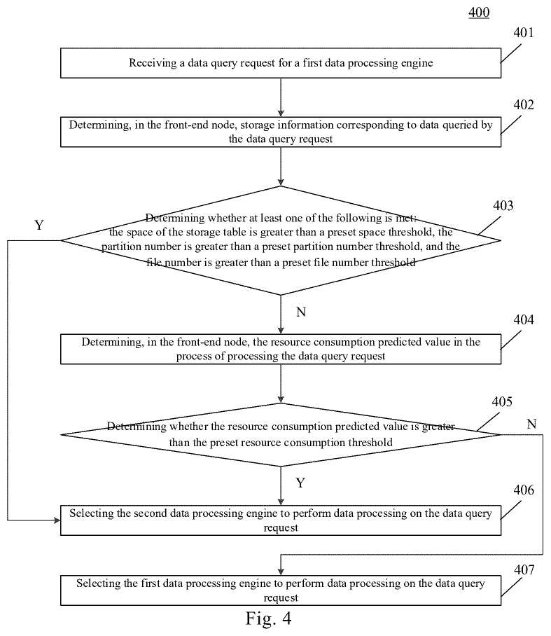

With further reference to FIG. 4, FIG. 4 shows a flow 400 of an embodiment of selecting a data processing engine in a data processing method. The flow 400 of selecting the data processing engine includes the following steps:

Step 401: receiving a data query request for a first data processing engine.

In this embodiment, the step 401 may be performed in a manner similar to that of step 101, and details are not described herein again.

Step 402: determining, in the front-end node, storage information corresponding to data queried by the data query request.

In this embodiment, the execution body of the data processing method may determine, in the front-end node, the storage information corresponding to the data queried by the data query request. The storage information may include at least one of the following: space of a storage table, a partition number, and a file number. The space of the storage table usually means space of a storage table in which the data queried by the data query request is located. The partition number usually means a quantity of areas from which the data queried by the data query request is originated. The file number usually means a quantity of files from which the data queried by the data query request is originated.

Step 403: determining whether at least one of the following is met: the space of the storage table is greater than a preset space threshold, the partition number is greater than a preset partition number threshold, and the file number is greater than a preset file number threshold.

In this embodiment, the execution body may determine whether the space of the storage table is greater than the preset space threshold, determine whether the partition number is greater than the preset partition number threshold, and determine whether the file number is greater than the preset file number threshold.

If it is determined that none of the following is met: the space of the storage table is greater than the preset space threshold, the partition number is greater than the preset partition number threshold, and the file number is greater than the preset file number threshold, the execution body may perform step 404.

If it is determined that at least one of the following is met: the space of the storage table is greater than the preset space threshold, the partition number is greater than the preset partition number threshold, and the file number is greater than the preset file number threshold, the execution body may perform step 406.

Step 404: if it is determined that none of the following is met: the space of the storage table is greater than the preset space threshold, the partition number is greater than the preset partition number threshold, and the file number is greater than the preset file number threshold, determining, in the front-end node, the resource consumption predicted value in the process of processing the data query request.

In this embodiment, if it is determined in step 403 that none of the following is met: the space of the storage table is greater than the preset space threshold, the partition number is greater than the preset partition number threshold, and the file number is greater than the preset file number threshold, the resource consumption predicted value in the process of processing the data query request may be determined in the front-end node. The resource may include but is not limited to at least one of the following: a CPU, a memory, a network, and I/O.

Step 405: determining whether the resource consumption predicted value is greater than the preset resource consumption threshold.

In this embodiment, the execution body may determine whether the resource consumption predicted value is greater than the preset resource consumption threshold. The execution body may compare the resource consumption predicted value with the preset resource consumption threshold. If it is determined that the resource consumption predicted value is greater than the preset resource consumption threshold, the execution body may perform step 406; or if it is determined that the resource consumption predicted value is less than or equal to the preset resource consumption threshold, the execution body may perform step 407.

Step 406: if it is determined that at least one of the following is met: the space of the storage table is greater than the preset space threshold, the partition number is greater than the preset partition number threshold, and the file number is greater than the preset file number threshold, or it is determined that the resource consumption predicted value is greater than the preset resource consumption threshold, selecting the second data processing engine to perform data processing on the data query request.

In this embodiment, if it is determined in step 403 that at least one of the following is met: the space of the storage table is greater than the preset space threshold, the partition number is greater than the preset partition number threshold, and the file number is greater than the preset file number threshold, or it is determined in step 405 that the resource consumption predicted value is greater than the preset resource consumption threshold, the execution body may select the second data processing engine with the higher processing capability to perform data processing on the data query request.

Step 407: if it is determined that the resource consumption predicted value is less than or equal to the preset resource consumption threshold, selecting the first data processing engine to perform data processing on the data query request.

In this embodiment, if it is determined, in step 405, that the resource consumption predicted value is less than or equal to the preset resource consumption threshold, the execution body may select the first data processing engine to perform data processing on the data query request.

It can be seen from FIG. 4 that, compared with the embodiment corresponding to FIG. 1, the flow 400 of the data processing method in this embodiment reflects the step in which the storage information corresponding to the data queried by the data query request and the resource consumption predicted value used to process the data query request are used to select the first data processing engine or the second data processing engine to perform data processing on the data query request. Therefore, based on the solution described in this embodiment, a corresponding data processing engine can be selected more properly for data processing.

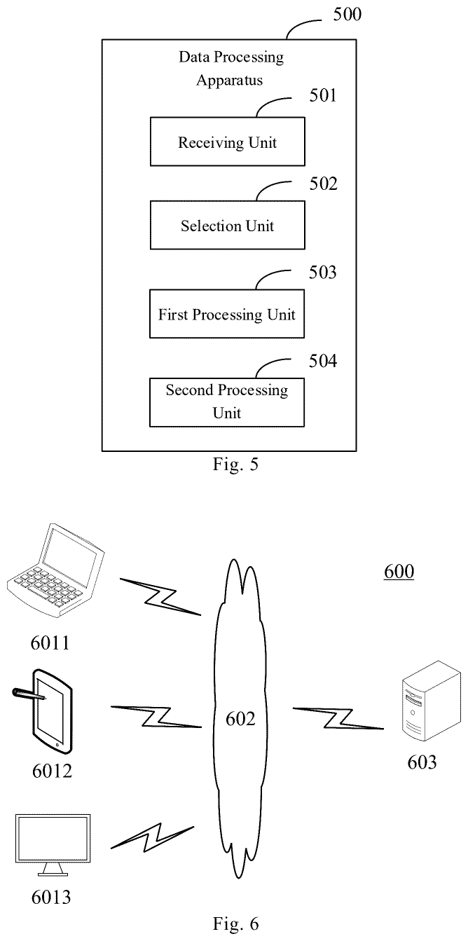

With further reference to FIG. 5, as an implementation for the method shown in the foregoing diagrams, this embodiment provides an embodiment of a data processing apparatus. The apparatus embodiment corresponds to the method embodiment shown in FIG. 1. The apparatus may be specifically applied to various electronic devices.

As shown in FIG. 5, a data processing apparatus 500 of this embodiment includes: a receiving unit 501, a selection unit 502, a first processing unit 503, and a second processing unit 504. The receiving unit 501 is configured to receive a data query request for a first data processing engine, where the first data processing engine includes a front-end node and a back-end node, the front-end node receives the data query request, and the back-end node stores data; the selection unit 502 is configured to select a target data processing engine from a data processing engine candidate set in the front-end node based on the data query request, where the target data processing engine performs data processing on the data query request, the data processing engine candidate set includes the first data processing engine and a second data processing engine, and a data processing capability of the second data processing engine is higher than that of the first data processing engine; the first processing unit 503 is configured to: if the target data processing engine is the first data processing engine, parse the data query request in the front-end node, and send a parsing result to the back-end node, so that the back-end node performs data query; and the second processing unit 504 is configured to: if the target data processing engine is the second data processing engine, generate target information in the front-end node based on the data query request, and send the target information to the second data processing engine, so that the second data processing engine obtains data from the first data processing engine for data query.

In this embodiment, for specific processing of the receiving unit 501, the selection unit 502, the first processing unit 503, and the second processing unit 504 of the data processing apparatus 500, reference may be made to the step 101, the step 102, the step 103, and the step 104 in the embodiment corresponding to FIG. 1.

In some optional implementations, the selection unit 502 may be further configured to select the target data processing engine from the data processing engine candidate set in the front-end node based on the data query request in the following manner: determining, in the front-end node, storage information corresponding to data queried by the data query request, where the storage information includes at least one of the following: space of a storage table, a partition number, and a file number; and selecting the second data processing engine as the target data processing engine in response to determining at least one of the following: the space of the storage table is greater than a preset space threshold, the partition number is greater than a preset partition number threshold, and the file number is greater than a preset file number threshold.

In some optional implementations, the selection unit 502 may be further configured to select the target data processing engine from the data processing engine candidate set in the front-end node based on the data query request in the following manner: determining, in the front-end node, a resource consumption predicted value in a process of processing the data query request; and selecting the second data processing engine as the target data processing engine in response to determining that the resource consumption predicted value is greater than a preset resource consumption threshold.

In some optional implementations, the second processing unit 504 may be further configured to: generate the target information in the front-end node based on the data query request, and send the target information to the second data processing engine in the following manner: parsing the data query request in the front-end node, to obtain a first dataset, where the first dataset can be processed by the first data processing engine; determining whether the first dataset can be converted into a second dataset, where the second dataset can be processed by the second data processing engine; and if yes, converting the first dataset into the second dataset, and using the second dataset as the target information for transmission to the second data processing engine.

In some optional implementations, the second processing unit 504 may be further configured to: if it is determined that the first dataset cannot be converted into the second dataset, use the data query request as the target information for transmission to the second data processing engine.

In some optional implementations, the data query request may include an engine identifier of a specified data processing engine; and the selection unit 502 may be further configured to select the target data processing engine from the data processing engine candidate set in the front-end node based on the data query request: selecting, in the data processing engine candidate set, a data processing engine specified by the data query request as the target data processing engine.

In some optional implementations, the second processing unit 504 may be further configured to: generate the target information in the front-end node based on the data query request, and send the target information to the second data processing engine in the following manner: in the front-end node, using the data query request as the target information for transmission to the second data processing engine.

In some optional implementations, the target information is the data query request; and the data processing apparatus 500 may include a determining unit (not shown in the figure) and a buffer unit (not shown in the figure). The determining unit is configured to determine whether metadata is buffered in the second data processing engine, where the metadata is metadata of a data table that stores data queried by the data query request; and the buffer unit is configured to: if the metadata is not buffered in the second data processing engine, obtain the metadata from the front-end node, buffer the metadata into a memory of the second data processing engine, and obtain data from the first data processing engine by using the metadata in the second data processing engine, for data query.

In some optional implementations, the data processing apparatus 500 may include a first obtaining unit (not shown in the figure). The foregoing obtaining unit is configured to: if the metadata is buffered in the second data processing engine, obtain the data from the first data processing engine by using the metadata in the second data processing engine, for data query.

In some optional implementations, the buffer unit or the first obtaining unit may be further configured to obtain the data from the first data processing engine by using the metadata in the second data processing engine, for data query in the following manner: sending a data obtaining request to the front-end node by using the metadata in the second data processing engine, and receiving data fed back by the front-end node for data query.

In some optional implementations, the buffer unit or the first obtaining unit may be further configured to obtain the data from the first data processing engine by using the metadata in the second data processing engine, for data query in the following manner: performing data pulling in the back-end node by using the metadata in the second data processing engine, and performing data query on pulled data.

In some optional implementations, data in the back-end node is stored in data tablets, and the metadata includes metadata of the data tablets; and data pulling may be performed in the back-end node by using the metadata in the following manner: generating at least one data pulling task according to the data tablets, where one data pulling task pulls data corresponding to at least one data tablet; and executing the at least one data pulling task, to perform data pulling in the back-end node.

In some optional implementations, the first processing unit 503 may be further configured to: parse the data query request in the front-end node, and send the parsing result to the back-end node, so that the back-end node performs data query in the following manner: parsing the data query request in the front-end node, to generate a physical execution plan, splitting the physical execution plan into a plurality of plan fragments, creating a fragment instance according to the plurality of plan fragments, and sending the fragment instance to the back-end node; and processing the fragment instance in the back-end node by using a pipeline link, to query data.

In some optional implementations, the data processing apparatus 500 may include a second obtaining unit (not shown in the figure). The second obtaining unit may be configured to obtain, in the front-end node, a processing result for the data query request from the second data processing engine.

In some optional implementations, the first data processing engine includes a massively parallel processing database, and the second data processing engine includes a distributed computing framework.

FIG. 6 shows an example system architecture 600 to which the embodiment of the data processing method of the present application is applicable.

As shown in FIG. 6, the system architecture 600 may include terminal devices 6011, 6012, and 6013, a network 602, and a server 603. The network 602 is configured to provide a medium of a communication link between the terminal devices 6011, 6012, and 6013, and the server 603. The network 602 may include various connection types, such as wired and wireless communication links or fiber optic cables.

A user may interact with the server 603 through the network 602 by using the terminal devices 6011, 6012, and 6013, to send or receive a message, or the like. For example, the server 603 may receive a data query request sent by the terminal devices 6011, 6012, and 6013 for the first data processing engine. Various communication client applications, such as short video software or search engines may be installed on the terminal devices 6011, 6012, and 6013.

The terminal devices 6011, 6012, and 6013 may be hardware or software. When the terminal devices 6011, 6012, and 6013 are hardware, the terminal devices may be various electronic devices with displays and supporting information exchange, including but not limited to a smartphone, a tablet computer, a laptop portable computer, and the like. When the terminal devices 6011, 6012, and 6013 are software, the terminal devices may be installed in the foregoing listed electronic devices. The terminal device may be implemented into a plurality of pieces of software or a plurality of software modules (for example, a plurality of pieces of software or a plurality of software modules configured to provide distributed services), or may be implemented into a single piece of software or a single software module. This is not specifically limited herein.

The server 603 may be a server that provides various services. The server 603 may be, for example, a back-end server that processes a data query request. The server 603 may receive a data query request for a first data processing engine, where the first data processing engine includes a front-end node and a back-end node, the front-end node receives the data query request, and the back-end node stores data; then, the server 603 may select a target data processing engine from a data processing engine candidate set in the front-end node based on the data query request, where the target data processing engine performs data processing on the data query request, the data processing engine candidate set includes the first data processing engine and a second data processing engine, and a data processing capability of the second data processing engine is higher than that of the first data processing engine; and if the target data processing engine is the first data processing engine, parse the data query request in the front-end node, and send a parsing result to the back-end node, so that the back-end node performs data query; or if the target data processing engine is the second data processing engine, generate target information in the front-end node based on the data query request, and send the target information to the second data processing engine, so that the second data processing engine obtains data from the first data processing engine for data query.

It should be noted that, the server 603 may be hardware or software. When the server 603 is hardware, the server 603 may be implemented into a distributed server cluster including a plurality of servers, or may be implemented into a single server. When the server 603 is software, the server 603 may be implemented into a plurality of pieces of software or a plurality of software modules (for example, configured to provide distributed services), or may be implemented into a single piece of software or a single software module. This is not specifically limited herein.

It should be further noted that, the data processing method provided in this embodiment of the present disclosure is usually performed by the server 603, and the data processing apparatus is usually disposed in the server 603.

It should be understood that, quantities of the terminal devices, networks, and servers in FIG. 6 are merely examples. There may be any quantity of terminal devices, networks, and servers according to an implementation requirement.

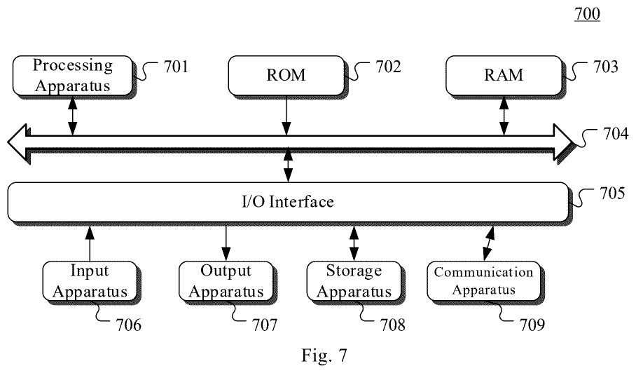

The following shows, with reference to FIG. 7, a schematic structural diagram of an electronic device (for example, the server in FIG. 6) 700 adapted to implement this embodiment of the present disclosure. The server shown in FIG. 7 is merely an example, and should not constitute any limitation on functions and use scope of embodiments of the present disclosure.

As shown in FIG. 7, the electronic device 700 may include a processing apparatus (such as a central processing unit, and a graphics processor) 701, it may execute various appropriate actions and processes according to a program stored in a read-only memory (ROM) 702 or a program loaded from a storage apparatus 708 to a random access memory (RAM) 703. In RAM 703, various programs and data required for operations of the electronic device 700 are also stored. The processing apparatus 701, ROM 702, and RAM 703 are connected to each other by a bus 704. An input/output (I/O) interface 705 is also connected to the bus 704.

Typically, the following apparatuses may be connected to the I/O interface 705: an input apparatus 706 such as a touch screen, a touchpad, a keyboard, a mouse, a camera, a microphone, an accelerometer, and a gyroscope; an output apparatus 707 such as a liquid crystal display (LCD), a loudspeaker, and a vibrator; a storage apparatus 708 such as a magnetic tape, and a hard disk drive; and a communication apparatus 709. The communication apparatus 709 may allow the electronic device 700 to wireless-communicate or wire-communicate with other devices so as to exchange data. Although FIG. 7 shows the electronic device 700 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 709, or installed from the storage apparatus 708, or installed from ROM 702. When the computer program is executed by the processing apparatus 701, the above functions defined in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The computer-readable medium may be included in the electronic device; or may exist independently without being assembled into the electronic device. The computer-readable medium carries one or more programs. When the one or more programs are executed by the electronic device, the electronic device is enabled to: receive a data query request for a first data processing engine, where the first data processing engine includes a front-end node and a back-end node, the front-end node receives the data query request, and the back-end node stores data; select a target data processing engine from a data processing engine candidate set in the front-end node based on the data query request, where the target data processing engine performs data processing on the data query request, the data processing engine candidate set includes the first data processing engine and a second data processing engine, and a data processing capability of the second data processing engine is higher than that of the first data processing engine; and if the target data processing engine is the first data processing engine, parse the data query request in the front-end node, and send a parsing result to the back-end node, so that the back-end node performs data query; or if the target data processing engine is the second data processing engine, generate target information in the front-end node based on the data query request, and send the target information to the second data processing engine, so that the second data processing engine obtains data from the first data processing engine for data query.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flowcharts and block diagrams in the accompanying drawings show system architectures, functions, and operations that may be implemented by systems, methods, and computer program products according to various embodiments of the present disclosure. In this regard, each block in the flowcharts or block diagrams may represent a module, a program segment, or a part of code, and the module, the program segment, or the part of the code includes one or more executable instructions for implementing a specified logical function. It should also be noted that, in some alternative implementations, functions marked in the blocks may also occur in a sequence different from that marked in the accompanying drawings. For example, two consecutively shown blocks may be actually executed substantially in parallel, or sometimes may be executed in a reverse sequence, depending on a function involved. It should also be noted that, each block in a block diagram and/or a flowchart, as well as combinations of blocks in the block diagram and/or the flowchart, may be implemented with a dedicated hardware-based system that performs a specified function or operation, or may be implemented with a combination of dedicated hardware and computer instructions.

The described units in embodiments of the present disclosure may be implemented by way of software or may be implemented by way of hardware. The described units may also be disposed in a processor. For example, it may be described as: a processor includes a receiving unit, a selection unit, a first processing unit, and a second processing unit. Names of these units do not constitute limitations on these units themselves in some cases. For example, the receiving unit may also be described as “a unit that receives a data query request for a first data processing engine”.

The foregoing descriptions are merely descriptions of preferred embodiments of the present disclosure and technical principles used in the present disclosure. A person skilled in the art should understand that the inventive scope involved in embodiments of the present disclosure is not limited to the technical solution formed by a particular combination of the foregoing technical features, but should also cover other technical solutions formed by any combination of the foregoing technical features or their equivalent features without departing from the foregoing inventive concept, for example, technical solutions formed by interchanging the foregoing features with (but not limited to) technical features having similar functions disclosed in embodiments of the present disclosure.

1. A data processing method, comprising:
receiving a data query request for a first data processing engine, wherein the first data processing engine comprises a front-end node and a back-end node, the front-end node receives the data query request, and the back-end node stores data;
selecting a target data processing engine from a data processing engine candidate set in the front-end node based on the data query request, wherein the target data processing engine performs data processing on the data query request, the data processing engine candidate set comprises the first data processing engine and a second data processing engine, and a data processing capability of the second data processing engine is higher than a data processing capability of the first data processing engine;
in response to the target data processing engine being the first data processing engine, parsing the data query request in the front-end node, and sending a parsing result to the back-end node, so that the back-end node performs data query; and
in response to the target data processing engine being the second data processing engine, generating target information in the front-end node based on the data query request, and sending the target information to the second data processing engine, so that the second data processing engine obtains data from the first data processing engine for data query.

2. The method according to claim 1, wherein the selecting a target data processing engine from a data processing engine candidate set in the front-end node based on the data query request comprises:
determining, in the front-end node, storage information corresponding to data queried by the data query request, wherein the storage information comprises at least one selected from a group consisting of: space of a storage table, a partition number, and a file number; and
selecting the second data processing engine as the target data processing engine in response to determining at least one selected from a group consisting of: the space of the storage table being greater than a preset space threshold, the partition number being greater than a preset partition number threshold, and the file number being greater than a preset file number threshold.

3. The method according to claim 1, wherein the selecting a target data processing engine from a data processing engine candidate set in the front-end node based on the data query request comprises:
determining, in the front-end node, a resource consumption predicted value in a process of processing the data query request; and
selecting the second data processing engine as the target data processing engine in response to determining that the resource consumption predicted value is greater than a preset resource consumption threshold.

4. The method according to claim 2, wherein the generating target information in the front-end node based on the data query request, and sending the target information to the second data processing engine comprises:
parsing the data query request in the front-end node, to obtain a first dataset, wherein the first dataset can be processed by the first data processing engine;
determining whether the first dataset is converted into a second dataset, wherein the second dataset can be processed by the second data processing engine; and
if yes, converting the first dataset into the second dataset, and using the second dataset as the target information for transmission to the second data processing engine.

5. The method according to claim 4, wherein after the determining whether the first dataset is converted into a second dataset, the method further comprises:
if no, using the data query request as the target information for transmission to the second data processing engine.

6. The method according to claim 1, wherein the data query request comprises an engine identifier of a specified data processing engine; and
the selecting a target data processing engine from a data processing engine candidate set in the front-end node based on the data query request comprises:
selecting, in the data processing engine candidate set, a data processing engine specified by the data query request as the target data processing engine.

7. The method according to claim 6, wherein the generating target information in the front-end node based on the data query request, and sending the target information to the second data processing engine comprises:
in the front-end node, using the data query request as the target information for transmission to the second data processing engine.

8. The method according to claim 1, wherein the target information is the data query request; and
after the generating target information based on the data query request, and sending the target information to the second data processing engine, the method further comprises:
determining whether metadata is buffered in the second data processing engine, wherein the metadata is metadata of a data table that stores data queried by the data query request; and
if no, obtaining the metadata from the front-end node, buffering the metadata into a memory of the second data processing engine, and obtaining data from the first data processing engine by using the metadata in the second data processing engine, for data query.

9. The method according to claim 8, wherein after the determining whether metadata is buffered in the second data processing engine, the method further comprises:
if yes, obtaining the data from the first data processing engine by using the metadata in the second data processing engine, for data query.

10. The method according to claim 8, wherein the obtaining data from the first data processing engine by using the metadata in the second data processing engine, for data query comprises:
sending a data obtaining request to the front-end node by using the metadata in the second data processing engine, and receiving data fed back by the front-end node for data query.

11. The method according to claim 8, wherein the obtaining data from the first data processing engine by using the metadata in the second data processing engine, for data query comprises:
performing data pulling in the back-end node by using the metadata in the second data processing engine, and performing data query on pulled data.

12. The method according to claim 11, wherein data in the back-end node is stored in data tablets, and the metadata comprises metadata of the data tablets; and
the performing data pulling in the back-end node by using the metadata comprises:
generating at least one data pulling task according to the data tablets, wherein one data pulling task pulls data corresponding to at least one data tablet; and
executing the at least one data pulling task, to perform data pulling in the back-end node.

13. The method according to claim 1, wherein the parsing the data query request in the front-end node, and sending a parsing result to the back-end node, so that the back-end node performs data query comprises:
parsing the data query request in the front-end node, to generate a physical execution plan, splitting the physical execution plan into a plurality of plan fragments, creating a fragment instance according to the plurality of plan fragments, and sending the fragment instance to the back-end node; and
processing the fragment instance in the back-end node by using a pipeline link, to query data.

14. The method according to claim 1, wherein the method further comprises:
obtaining, in the front-end node, a processing result for the data query request from the second data processing engine.

15. The method according to claim 1, wherein the first data processing engine comprises a massively parallel processing database, and the second data processing engine comprises a distributed computing framework.

16. An electronic device, comprising:
at least one processor; and
at least one memory, storing one or more programs, wherein
upon the one or more programs being executed by the at least one processor, the at least one processor is enabled to implement a data processing method, which comprises:
receiving a data query request for a first data processing engine, wherein the first data processing engine comprises a front-end node and a back-end node, the front-end node receives the data query request, and the back-end node stores data;
selecting a target data processing engine from a data processing engine candidate set in the front-end node based on the data query request, wherein the target data processing engine performs data processing on the data query request, the data processing engine candidate set comprises the first data processing engine and a second data processing engine, and a data processing capability of the second data processing engine is higher than a data processing capability of the first data processing engine;
in response to the target data processing engine being the first data processing engine, parsing the data query request in the front-end node, and sending a parsing result to the back-end node, so that the back-end node performs data query; and
in response to the target data processing engine being the second data processing engine, generating target information in the front-end node based on the data query request, and sending the target information to the second data processing engine, so that the second data processing engine obtains data from the first data processing engine for data query.

17. The electronic device according to claim 16, wherein the selecting a target data processing engine from a data processing engine candidate set in the front-end node based on the data query request comprises:
determining, in the front-end node, storage information corresponding to data queried by the data query request, wherein the storage information comprises at least one selected from a group consisting of: space of a storage table, a partition number, and a file number; and
selecting the second data processing engine as the target data processing engine in response to determining at least one selected from a group consisting of: the space of the storage table being greater than a preset space threshold, the partition number being greater than a preset partition number threshold, and the file number being greater than a preset file number threshold.

18. The electronic device according to claim 16, wherein the selecting a target data processing engine from a data processing engine candidate set in the front-end node based on the data query request comprises:
determining, in the front-end node, a resource consumption predicted value in a process of processing the data query request; and
selecting the second data processing engine as the target data processing engine in response to determining that the resource consumption predicted value is greater than a preset resource consumption threshold.

19. The electronic device according to claim 18, wherein the generating target information in the front-end node based on the data query request, and sending the target information to the second data processing engine comprises:
parsing the data query request in the front-end node, to obtain a first dataset, wherein the first dataset can be processed by the first data processing engine;
determining whether the first dataset is converted into a second dataset, wherein the second dataset can be processed by the second data processing engine; and
if yes, converting the first dataset into the second dataset, and using the second dataset as the target information for transmission to the second data processing engine.

20. A non-transient computer-readable medium, storing a computer program, wherein the computer program, upon being executed by a processor, perform a data processing method, which comprises:
receiving a data query request for a first data processing engine, wherein the first data processing engine comprises a front-end node and a back-end node, the front-end node receives the data query request, and the back-end node stores data;
selecting a target data processing engine from a data processing engine candidate set in the front-end node based on the data query request, wherein the target data processing engine performs data processing on the data query request, the data processing engine candidate set comprises the first data processing engine and a second data processing engine, and a data processing capability of the second data processing engine is higher than a data processing capability of the first data processing engine;
in response to the target data processing engine being the first data processing engine, parsing the data query request in the front-end node, and sending a parsing result to the back-end node, so that the back-end node performs data query; and
in response to the target data processing engine being the second data processing engine, generating target information in the front-end node based on the data query request, and sending the target information to the second data processing engine, so that the second data processing engine obtains data from the first data processing engine for data query.
